(19) United States
(12) Patent Application Publication
(10) Pub. No.: US 2026/0318509 A1
(43) Pub. Date: Oct. 15, 2026

(54) TROFFER LIGHT FIXTURE AND APPLICATIONS THEREOF

(71) Applicant: CREE LIGHTING USA LLC, Racine, WI (US)

(72) Inventors: Corey Goldstein, Milwaukee, WI (US); Jeremy Sorenson, Oak Creek, WI (US); David P. Goelz, Milwaukee, WI (US); Mario A. Castillo, New Braunfels, TX (US); Kurt Wilcox, Libertyville, IL (US)

(21) Appl. No.: 19/179,583

(22) Filed: Apr. 15, 2025

(51) Int. Cl. F21V 17/06; F21V 17/16

(52) U.S. Cl. CPC F21V 17/06; F21V 17/16

(57) ABSTRACT

Troffer light fixtures are described herein comprising architecture, including lens mountings, which reduce or eliminate tooling requirements for lens installation and maintenance.

### FIELD

The present application relates to light fixtures and, in particular, to troffer light fixtures comprising lens mounting assemblies which reduce or eliminate tooling requirements for lens installation and/or maintenance.

### BACKGROUND

Light fixture design is wide and varied depending on application and associated lighting characteristics. Current troffer light fixtures can include a lens or optic positioned within the recessed body of the troffer for providing the desired lighting distribution. Prior designs require bolts or screws to couple a lens to the lighting assembly. This design is cumbersome, often requiring the removal of housing panels, such as end caps, while necessitating correct placement of small screws through portions of the fixture housing and/or lens to engage the lighting assembly. Additionally, this design requires tooling, such as a screwdriver, drill or other rotational tool, to lock the bolts or screws into place. In many cases, the lens is coupled to the lighting assembly after the lighting assembly has been mounted to a ceiling, thereby further complicating the correct placement and tightening of bolts and/or screws.

### SUMMARY

In view of the foregoing disadvantages, troffer light fixtures are described herein comprising architecture, including lens mountings, which reduce or eliminate tooling requirements for lens installation and maintenance. In some embodiments, a troffer light fixture comprises a first end, a second end, and a body extending between the first end and the second end. A light source is positioned in the body, and a lens mounting comprising at least one reversibly compressible assembly arranged at the first end or the second end. A lens covers the light source and contacts the reversibly compressible assembly. The lens mounting, in some embodiments, comprises a plurality of reversibly compressible assemblies, one assembly mounted at the first end and another mounted at the second end. Moreover, in some embodiments, the first end and the second end are fixedly attached to the body and, accordingly, do not move. The first end, the second end, and the body, in some embodiments, form a monolithic or single-piece structure. In some embodiments, the body extending between the first and second ends is recessed.

In another aspect, a light fixture comprises a lens secured over a light source and extending between first and second ends, and at least one reversibly compressible structure in contact with the lens at one of the first and second ends and permitting removal of the lens upon compression of the structure allowing movement of the lens with respect to the light source. In some embodiments, movement of the lens can be in the lateral direction in response to compression of the structure. The light fixture is a troffer light fixture, in some embodiments.

In another aspect, methods of installing or servicing a lens of a troffer light fixture are described herein. In some embodiments, a method comprising providing a troffer light fixture comprising a first end, a second end, and a body extending between the first end and the second end; a light source positioned in the body; and a lens mounting comprising a first reversibly compressible assembly arranged at the first end. The first reversibly compressible assembly is compressed with a first end of a lens. Compression of the first reversibly compressible assembly is subsequently released to secure a second end of the lens at the second end of the body. The lens can subsequently be removed from the troffer light fixture for maintenance or replacement. The first reversibly compressible assembly, for example, can be compressed with the first end of the lens to unsecure the second end of the lens at the second end of the body. The lens is then removed from the troffer light fixture. As described herein, the body extending between the first and second ends is recessed, in some embodiments.

These and other embodiments are further described in the following detailed description.

### BRIEF DESCRIPTION OF THE DRAWINGS

FIG. 1 illustrates a perspective view of a troffer light fixture according to some embodiments described herein.

FIG. 2 illustrates a perspective view of a reversibly compressible assembly, according to some embodiments.

FIG. 3 illustrates a reversibly compressible assembly of a lens mounting positioned at a first or second end of the recessed body, according to some embodiments.

FIG. 4 illustrates a partial cross-sectional view of troffer light fixture described herein according to some embodiments.

FIG. 5 is a perspective view of a back side of the troffer light fixture illustrated in FIG. 1.

FIG. 6 illustrates a sectional perspective view of a driver assembly coupled to an outer surface of the recessed body according to some embodiments.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

As described herein, a troffer light fixture comprises a first end, a second end, and a recessed body extending between the first end and the second end. A light source is positioned in the recessed body, and a lens mounting comprising at least one reversibly compressible assembly is arranged at the first end or the second end. A lens covers the light source and contacts the at least at least one reversibly compressible assembly. Turning now to specific components, the recessed body extending between the first and second ends of the troffer light fixture can have any desired geometry or design consistent with the technical objectives described herein. In some embodiments, the recessed body exhibits a polygonal cross-section including, but not limited to, square, rectangular, or trapezoidal. Alternatively, the recessed body can exhibit a circular or elliptical cross-section. In some embodiments, depth of the recessed body gradually increases in a direction away from a first side of the body and reaching a maximum along the longitudinal centerline of the body. Depth of the recessed body subsequently decreases in a direction away from the longitudinal centerline and approaching a second side of the body opposite the first side. Accordingly, for polygonal cross-sections having this variable depth profile, maximum depth of the recessed body can occur in a vertex region. Moreover, for circular or elliptical cross-sections, maximum depth of the recessed body can occur in a region of maximum radius of curvature.

In some embodiments, the first and second ends are fixedly attached to the recessed body. In being fixedly attached, the first and second ends do not move. In some embodiments, the first end, the second end, and the recessed body form a monolithic structure. For example, the monolithic structure including the first end, the second end, and the recessed body can be formed by stamping or pressing metal, such as aluminum. Alternatively, the monolithic structure can be fabricated via molding, including molding plastic. In some embodiments, the first end and the second end each form an obtuse angle with a bottom surface of the recessed body. The obtuse angle can range from greater than 90 degrees up to 130 degrees, in some embodiments. The first end and the second end can also be normal to bottom surface of the recessed body.

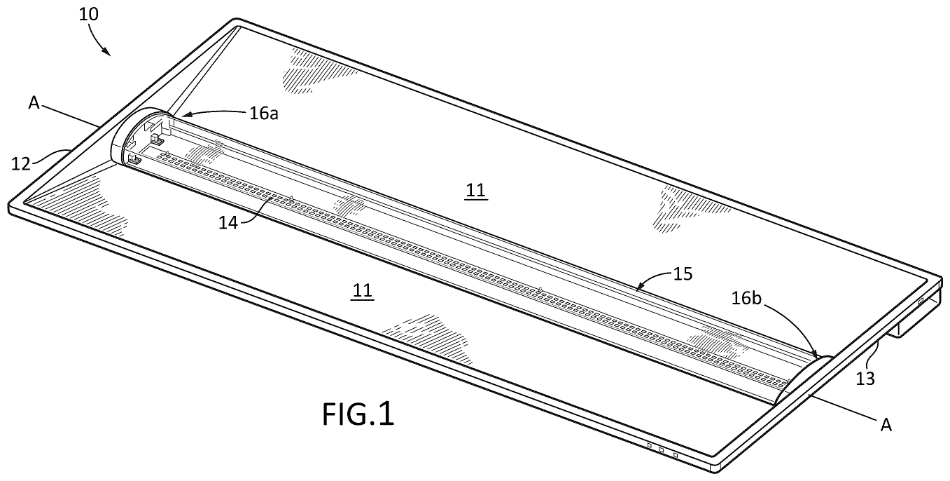

FIG. 1 illustrates a perspective view of a troffer light fixture according to some embodiments described herein. As provided in FIG. 1, the recessed body 11 and associated first 12 and second 13 ends have a trapezoidal cross-section. A light source 14 is positioned along the central longitudinal axis (A) of the troffer light fixture 10. In the embodiment of FIG. 1, the light source 14 comprises a light emitting diode (LED) array. A lens or optic 15 is arranged over the LED array 14. The lens 15 in FIG. 1 is clear for illustration purposes, but can adopt several different architectures including reflective elements, total internal reflection elements, refractive elements, and/or combinations thereof. The lens 15 is coupled to a lens mounting. In the embodiment of FIG. 1, the lens mounting comprises a first reversibly compressible assembly 16a arranged at the first end 12 and a second reversibly compressible assembly 16b arranged at the second end 13.

A reversible compressible assembly of troffer light fixtures described herein can comprise any desired architecture, structure, or design consistent with facilitating lens mounting and maintenance. In some embodiments, a reversibly compressible assembly comprises a monolithic compressible material, such as a foam body. Alternatively, a reversibly compressible assembly comprises a backplate and contact plates extending through apertures in the backplate, the contact plates being reversible compressible. In some embodiments, the backplate is coupled to a bottom surface of the recessed body. Moreover, the reversibly compressible assembly can further comprise an outer cover defining an aperture between the backplate and outer cover for receiving the lens.

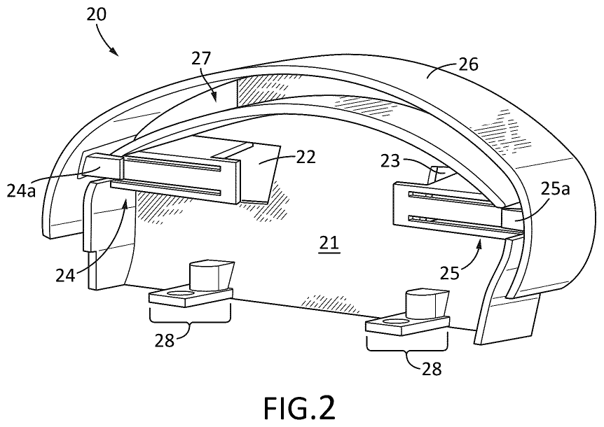

FIG. 2 illustrates a perspective view of a reversibly compressible assembly, according to some embodiments. In the embodiment of FIG. 2, the backplate 21 of the reversibly compressible assembly 20 comprises apertures 22, 23 through which contact plates 24, 25 extend. The reversibly compressible assembly also comprises an outer cover 26. The outer cover 26 in conjunction with the backplate 21 define an aperture 27 for receiving an end of the troffer light fixture lens. The aperture can have a shape matching or substantially matching the cross-sectional shape of the lens. In the embodiment of FIG. 2, the aperture 27 has an elliptical shape, however, circular, curvilinear, and polygonal shapes are also contemplated. End portions 24a, 25a of the contact plates 24, 25 extend into the aperture 27 for contacting the lens. Portions 24a, 25a are reversibly compressible. In some embodiments, the entirety of the contact plates 24, 25 are reversibly compressible. The reversibly compressible assembly, in some embodiments, comprises brackets, slots, protrusions or other mechanisms for coupling to the recessed body and/or first or second end. In the embodiment of FIG. 2, the reversibly compressible assembly 20 comprises brackets 28 for coupling to the bottom surface of the recessed body.

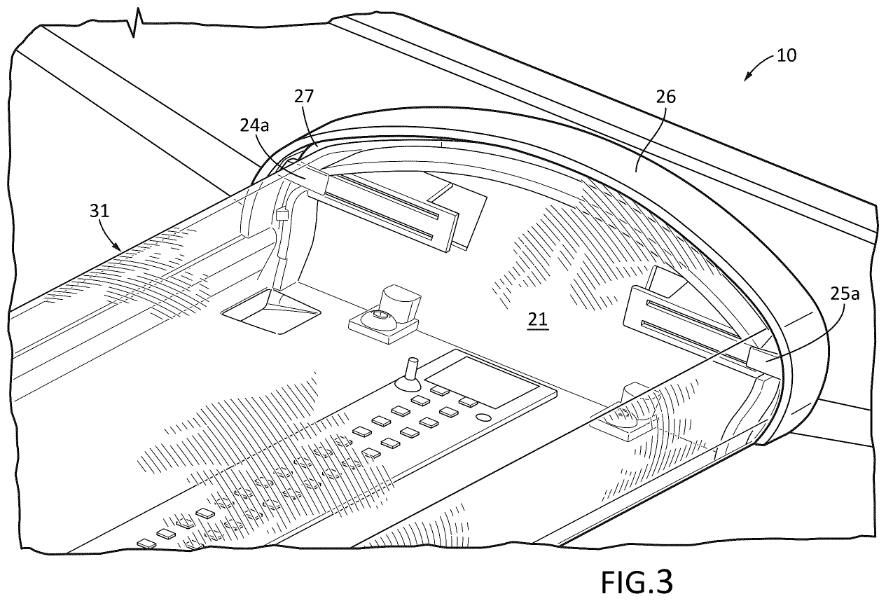

FIG. 3 illustrates a reversibly compressible assembly of a lens mounting positioned at a first or second end of the recessed body, according to some embodiments. As provided in FIG. 3, a lens 31 inserts into the aperture 27 formed by the backplate 21 in conjunction with the outer cover 26. The lens 31 contacts end portions 24a, 25a of contact plates 24, 25. A force applied to the lens 31 along the longitudinal axis of the troffer light fixture 10 compresses the end portions 24a, 25a. In the absence of such a force, the end portions 24a, 25a reside in the uncompressed state or position.

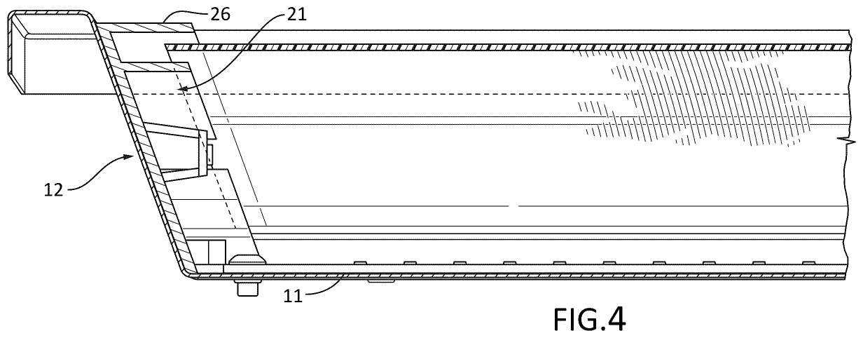

Additionally, as described above, the first end and or second end of the troffer fixture can form an obtuse angle or right angle with a bottom surface of the recessed body. The reversibly compressible assembly can have a design addressing the angle formed between the first or second end and the bottom surface of the recessed body. In some embodiments, the backplate and outer cover are angled to match the angle of the first or second end. FIG. 4 illustrates a partial cross-sectional view of troffer light fixture described herein according to some embodiments. As illustrated in FIG. 4, the backplate 21 and outer cover 26 of the reversibly compressible assembly 20 match the obtuse angle formed between the first or second end 12 and bottom of the recessed body 11. In this way, the reversibly compressible assembly is supported by the first end or second end and the bottom surface of the recessed body. Such support can inhibit or preclude the reversibly compressible assembly from becoming displaced during compression when installing or removing the lens.

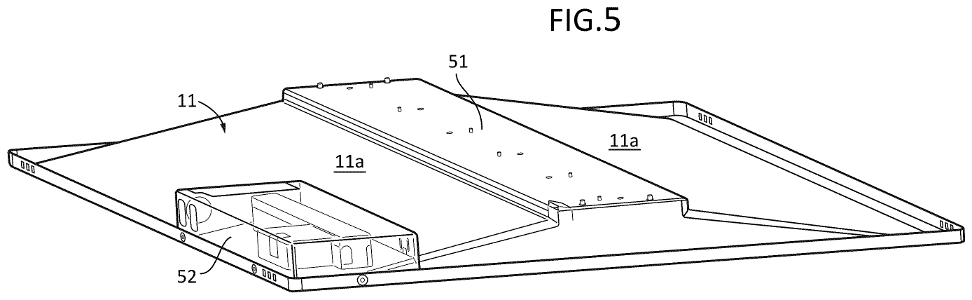

The first end, second end, and recessed body also form outer surfaces of the troffer light fixture. FIG. 5 is a perspective view of a back side of the troffer light fixture illustrated in FIG. 1. The generally trapezoidal cross section of the recessed body 11 provides a vertex region 51 in the outer surface 11a. As provided in FIG. 1, the vertex region 51 corresponds to the bottom surface of the recessed body 11 where the LED array is housed. A driver assembly 52 is coupled to the outer surface 11a. In the embodiment of FIG. 5, the driver assembly 52 is spaced apart from the vertex region 51. In some embodiments, height of the driver assembly 52 is less than or equal to the height of the vertex region 51. Such an arrangement can facilitate packing efficiencies when shipping or deploying troffer light fixtures described herein to a worksite for installation.

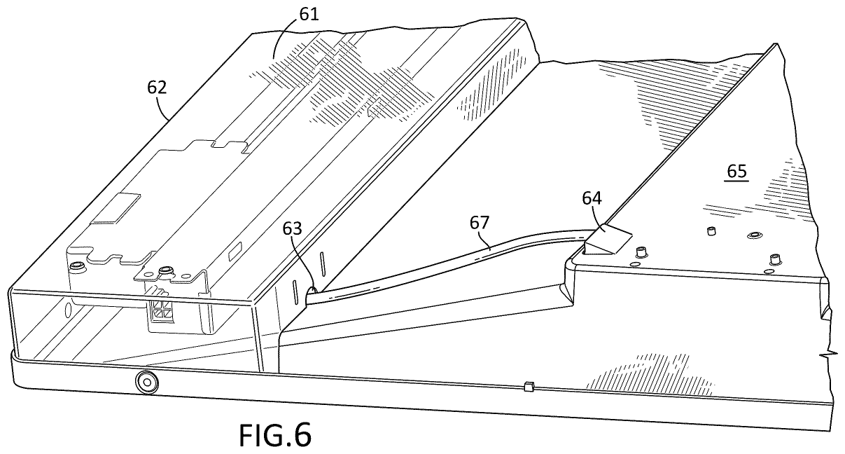

The driver assembly housing can comprise an aperture for passing an electrical connection to an aperture in the recessed body for supplying electrical power to the LED array or other light source of the troffer light fixture. The electrical connection can include suitable components for environmental shielding such as sheathing or a sealed conduit between the driver housing and the aperture in the recessed body. FIG. 6 illustrates a sectional perspective view of a driver assembly coupled to an outer surface of the recessed body according to some embodiments. The housing 62 of the driver assembly 61 comprises an aperture 63 for passing an electrical connection 67 from the driver assembly to an aperture 64 in the recessed body 65. In the embodiment of FIG. 6, the aperture 64 in the recessed body 65 is located in the vertex region 66 housing the LED array of the troffer fixture.

In another aspect, methods of installing or servicing a lens of a troffer light fixture are described herein. In some embodiments, a method comprising providing a troffer light fixture comprising a first end, a second end, and a recessed body extending between the first end and the second end; a light source positioned in the recessed body; and a lens mounting comprising a first reversibly compressible assembly arranged at the first end. The first reversibly compressible assembly is compressed with a first end of a lens. Compression of the first reversibly compressible assembly is subsequently released to secure a second end of the lens at the second end of the recessed body. Securing the lens at the second end of the recessed body by release of compression on the first reversibly compressible assembly can ensure proper positioning of the lens in the troffer light fixture.

The lens can subsequently be removed from the troffer light fixture for maintenance or replacement. The first reversible assembly, for example, is compressed with the first end of the lens to unsecure the second end of the lens at the second end of the recessed body. The lens is then removed from the troffer light fixture.

Methods provided herein are further described with reference to the non-limiting embodiments illustrated in FIGS. 1 and 3. As provided in FIG. 1, the lens 15 is secured by the reversible compressive assemblies 16a and 16b residing at the first 12 and second 13 ends of the recessed body 11, respectively. The lens 15 can be removed by applying a force on the lens 15 in a direction along the central longitudinal axis (A) towards the first end 12. The force can be manually applied by an individual. Application of this force results in the lens 15 compressing the end portions 24a, 25a of the contact plates 24, 25 of the reversible compressive assembly 16a, as illustrated in FIG. 3. Such compression permits the lens 15 to move a distance in the direction of the first end 12. This movement permits the second end of the lens 15 to depart the aperture of the reversibly compressible assembly 16b at the second end of the lens. Departure from the aperture allows the lens 15 to be removed from the troffer light fixture for replacement or maintenance.

The lens 15 can be reattached to the troffer light fixture by inserting the first end of the lens 15 into the aperture 27 of the first reversibly compressible assembly 16a. A force is manually applied to the lens 15 in a direction along the central longitudinal axis (A) towards the first end 12 to compress the end portions 24a, 25a of the contact plates 24, 25 of the reversible compressive assembly 16a. This compression permits the lens 15 to move a distance in the direction of the first end 12, thereby creating lateral clearance for the second end of the lens to align with the aperture of the second reversibly compressive assembly 16b. Releasing the compression moves the second end of the lens 15 into the aperture of the second reversibly compressive assembly 16b, thereby securing the lens 15 to the troffer light fixture. Securing the lens 15 in this manner ensures proper alignment of the lens 15 in the troffer light fixture. In the embodiments of FIGS. 1 and 3, the force can be manually applied towards the second end 13 for compression of the second reversibly compressible assembly 16b to initiate lens installation or removal as described herein. Moreover, lens installation or removal can be achieved with a single reversibly compressible assembly positioned at the first end or the second end. Notably, the lens installation and/or removal can be achieved without any tooling and without sacrificing proper lens placement in the troffer light fixture.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A troffer light fixture comprising:
a first end, a second end, and a body extending between the first end and the second end;
a light source positioned in the body;
a lens mounting comprising at least one reversibly compressible assembly arranged at the first end or the second end; and
a lens covering the light source and contacting the at least one reversibly compressible assembly.

2. The troffer light fixture of claim 1, wherein the reversibly compressible assembly comprises a backplate and contact plates extending through apertures in the backplate, the contact plates being reversibly compressible.

3. The troffer light fixture of claim 2, wherein an end of the lens engages the contact plates.

4. The troffer light fixture of claim 2, wherein the backplate is coupled to a bottom surface of the body.

5. The troffer light fixture of claim 2, wherein the reversibly compressible assembly further comprises an outer cover over the backplate defining an aperture between the backplate and outer cover for receiving the end of the lens.

6. The troffer light fixture of claim 1, wherein the first end and the second end are fixedly attached to the body.

7. The troffer fixture of claim 1, wherein the first end, the second end, and the body form a monolithic structure.

8. The troffer fixture of claim 1, wherein the first end and the second end each form an obtuse angle with a bottom surface of the body.

9. The troffer light fixture of claim 1 further comprising a driver coupled to an outer surface of the body.

10. The troffer light fixture of claim 9, wherein height of the driver does not exceed a vertex height of the outer surface of the body.

11. The troffer light fixture of claim 10 further comprising an electrical connection traveling from the driver to an aperture in the vertex of the body.

12. The troffer light fixture of claim 2, wherein the lens mounting comprises the reversibly compressive assembly arranged at the first end and the second end.

13. The troffer of claim 1, wherein the lens comprises refractive optical elements, reflective optical elements, or combinations thereof.

14. A light fixture comprising:
a lens secured over a light source and extending between first and second ends; and
at least one reversibly compressible structure in contact with the lens at one of the first and second ends and permitting removal of the lens upon compression of the assembly allowing movement of the lens with respect to the light source.

15. The light fixture of claim 14, wherein the at least one reversibly compressible structure is in contact with an end of the lens.

16. The light fixture of claim 14, wherein movement of the lens is in the lateral direction.

17. A method of installing or servicing a lens of a troffer light fixture comprising:
providing the troffer light fixture comprising:
a first end, a second end, and a body extending between the first end and the second end;
a light source positioned in the body;
a lens mounting comprising a first reversibly compressible assembly arranged at the first end; and
compressing the first reversibly compressible assembly with a first end of the lens; and
releasing compression of the first reversibly compressible assembly to secure a second end of the lens at the second end of the body.

18. The method of claim 17, wherein the lens installation does not require tooling external to the troffer light fixture.

19. The method of claim 17, wherein the first reversibly compressible assembly comprises a backplate and contact plates extending through apertures in the backplate, the contact plates being reversibly compressible.

20. The method of claim 17 further comprising compressing the first reversible assembly with the first end of the lens to unsecure the second end of the lens at the second end of the body and removing the lens from the troffer light fixture.
